(19) United States
(12) Patent Application Publication
(10) Pub. No.: US 2007/0199644 A1
(43) Pub. Date: Aug. 30, 2007

(54) Method of covering an automobile shift knob with leather

(76) Inventors: Ernesto Cisneros Flores, H Matamoros (MX); Leonardo Camacho Araiza, H Matamoros (MX); Eduardo Jonas Sanchez Vazquez, Cd. Valle Hermosos (MX)

Correspondence Address: YOUNG & BASILE, P.C., 3001 WEST BIG BEAVER ROAD, SUITE 624, TROY, MI, 48084, US

(21) Appl. No.: 11/361,650

(22) Filed: Feb. 24, 2006

(51) Int. Cl. B32B 37/12; B32B 38/04; B32B 38/00; B32B 38/10

(52) U.S. Cl. 156/93; 156/264; 156/153

(57) ABSTRACT

A method of covering a contoured automotive component such as a shift knob with leather such that the leather is pieced and has the appearance of being stitched together along at least one seam. The cut pieces are thinned, adhesively hemmed, thinned again and provided with false stitching. Thereafter, the hemmed, thinned and stitched pieces are coated with adhesive and applied to the surface of the shift knob in complemental, edge-matching fashion.

### FIELD OF THE INVENTION

This invention relates to a method for covering shift knobs and/or other automotive interior components with leather in such a way as to create the appearance of a stitched-together unit of one or more leather pieces.

### BACKGROUND

The use of leather in the interior of automobiles has become extremely popular, particularly with “sport” models. Leather appears not only on seating surfaces but on door trim, steering wheels and shift knobs. On steering wheels and shift knobs, it has become particularly fashionable to add seam stitching.

The assembly of a stitched leather cover to a complex shape such as a steering wheel or shift knob is labor intensive and, therefore, expensive as it requires a substantial amount of hand working. Cost is always a factor in the automobile industry and suppliers are under constant pressure to provide fashionable and high quality products at the lowest possible cost.

### SUMMARY

The subject invention lies in a method for producing a leather-covered shift knob or other component with simulated seam stitching, but requiring less hand work, particularly insofar as actually stitching the mating edges together. In general, the invention comprises the steps of cutting or otherwise providing one or more pieces of leather which are top-finished to a predetermined shape and area of coverage, thinning and hemming the edges to be matched and thereafter adding “false” stitching which runs along or through the matching edges but which does not join the edges. Finally, the unfinished side or sides are adhesively bonded to the component to be covered.

In the embodiment hereinafter described for purposes of illustration, the object to be covered is a smooth, plastic shift knob and the leather is cut into two complemental pieces defining one contoured seam of matched edges. It is to be understood that the process described below can be used to cover other objects such as steering wheels which typically require only one cut piece of leather.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a perspective view of an automobile interior showing the location of a leather-covered shift knob;

FIG. 2 shows two pieces of complementally shaped leather cut in accordance with the first step of the invention;

FIG. 3 is a side view of a cut leather piece;

FIG. 4 is a side view in slightly larger scale showing the edge thinning operation;

FIG. 5 is a side view showing the results of the hemming step;

FIG. 6 is a side view showing the results of the post-hemming thinning step;

FIG. 7 is a perspective view of one of the pieces of FIG. 1 after the stitching step;

FIG. 8 shows the application of adhesive to the underside of one of the hemmed stitch pieces;

FIG. 9 shows the assembly of the adhesively coated hemmed stitched pieces to a shift knob; and

FIG. 10 illustrates the completed shift knob with leather covering.

### DETAILED DESCRIPTION

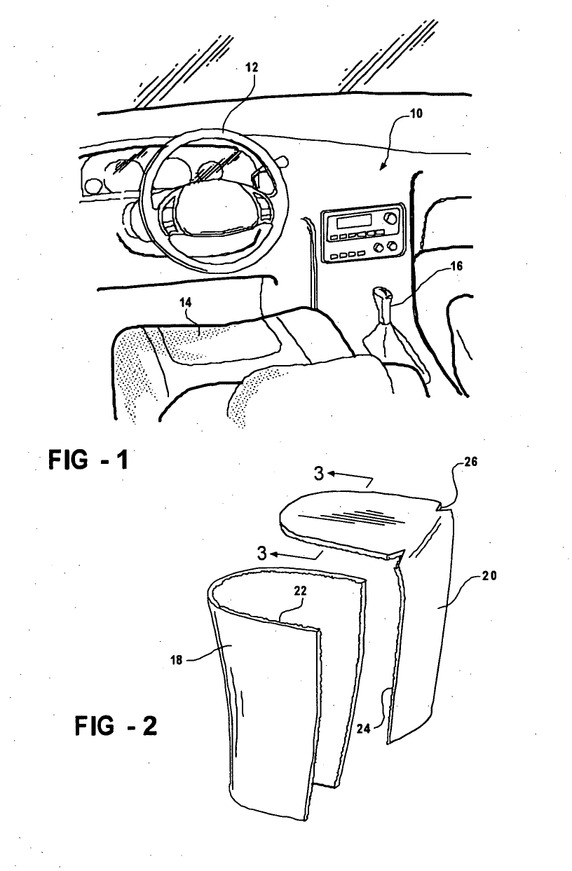

Referring now to the drawings, FIG. 1 shows the interior of an automobile having a left side mounted steering wheel 12, a bucket type drivers seat 14 and a shift knob 16 adapted to control the operation of the vehicle transmission.

The steps of the illustrative method are illustrated in FIGS. 2-10. The first step consists of the substeps of selecting a suitable amount of top-finished leather of the desired thickness and pliability. The term “top finished” is used to describe leather which is either tanned and smooth or sueded on one side using conventional technology and the other or opposite side is left rough. This may be whole or split hides. It is to be understood that the unfinished rough surface in the context of the following explanation is the surface which actually contacts the smooth plastic surface of the shift knob 15 which is to be covered.

In FIG. 2, pieces 18 and 20 have been die-cut from a larger quantity of top-finished leather material in shapes which are complemental to one another, and which, when assembled with the edges 22 and 24 in juxtaposition, will produce an area which initially slightly exceeds the surface area of the shift knob 15 so that the pieces overlap to approximately 3 of an inch. The edge 24 may be provided with a series of small notches as shown at 26 purely for purposes of illustration; i.e., the number and sizes of the notches 26 may be varied as necessary to allow the piece 20 to be folded essentially as shown to close the notches and to prevent wrinkling or bumping along the folded or curved area.

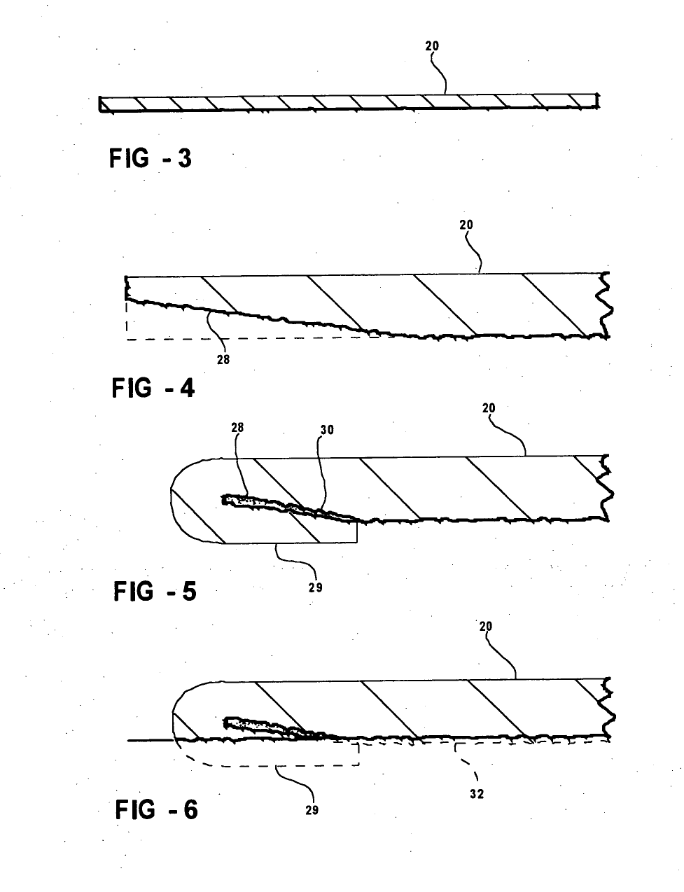

FIGS. 3 and 4 illustrate the next step in the method which is the step of thinning both of the pieces along and proximate to matching edges by removing material from the non-finished surface to produce a new, thinned surface 28 as shown in FIG. 4. This step is typically referred to as “skiving” and may be performed by cutting or abrading equipment.

The next step in the production method is to hem the pieces 18 and 20 by applying adhesive 30 to the hemmed surface 28 and folding the hemmed surface on itself to produce a hemmed area 29. In FIG. 5, the thickness of the hemmed area 29 is exaggerated slightly; i.e., the thinning step may be sufficient to remove enough material such that the hemmed area is approximately the same thickness as the original piece 20 prior to the performance of the thinning step. It may be desirable to use dies in this step to ensure that the hemmed pieces are of the needed surface area. Hemming reduces the original surface area so the pieces now exactly match the surface area to be covered.

As shown in FIG. 6, the next step is to thin or skive the entire piece 20 by removing material from the unfinished, underside as well as from the hemmed area 29 to provide a fresh surface 32 opposite the finished surface of the piece 20. This step is performed not only to make the material more pliable but also to produce a surface which is optimally receptive to adhesive as is further explained with reference to FIG. 8.

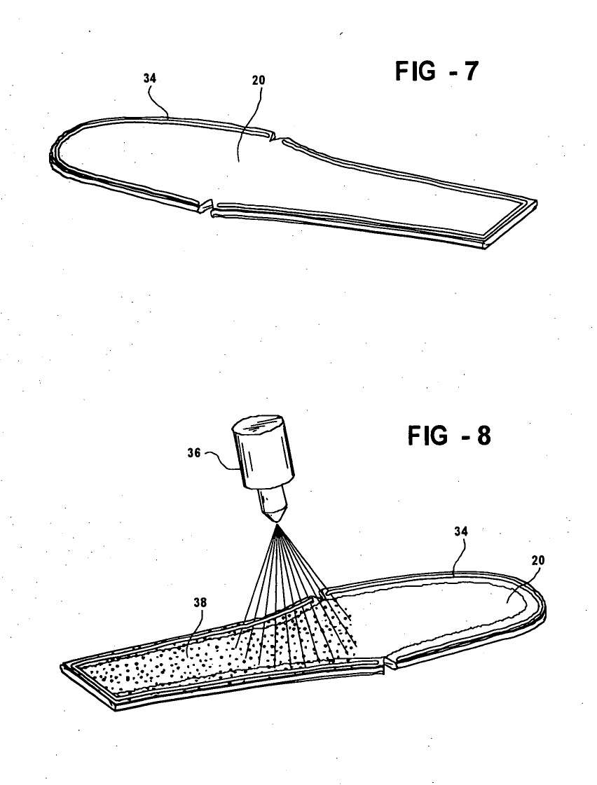

Looking now to FIG. 7, the next step of the method is to apply false stitching 34 to the hemmed edge of both pieces, the piece 20 being illustrated in FIG. 7 so as to represent the process step which is carried out on both pieces 18 and 20. As stated above, the stitching material can be heavy thread and/or strand leather. In addition, holes may be punched in the piece 20 along the edge to lock the stitching. The pre-punching of holes is optional since the use of sharp needles through the thin material may also suffice to penetrate the material for the purpose of allowing the stitching to pass through the material and be pulled tight. The stitching 34 is obviously not pulled so tight as to distort the edge.

The stitching used by way of illustration is called “French” stitching which runs parallel to the edges to be joined. However, looped or “baseball” stitching may also be used.

As shown in FIG. 8, the piece 20 is now fully hemmed, thinned and stitched and is ready to receive on the fresh undersurface a coating of adhesive 38 which is supplied by means of a spray nozzle 30. The adhesive may also be hand applied. Adhesive is also preferably applied to the surface of the shift knob 15 after a brief sanding operation to rough up the surface of the plastic shift knob to make it more receptive to the adhesive. The preferred adhesive is not a so-called “contact” cement which would prevent movement of the leather pieces over the knob surface after contact.

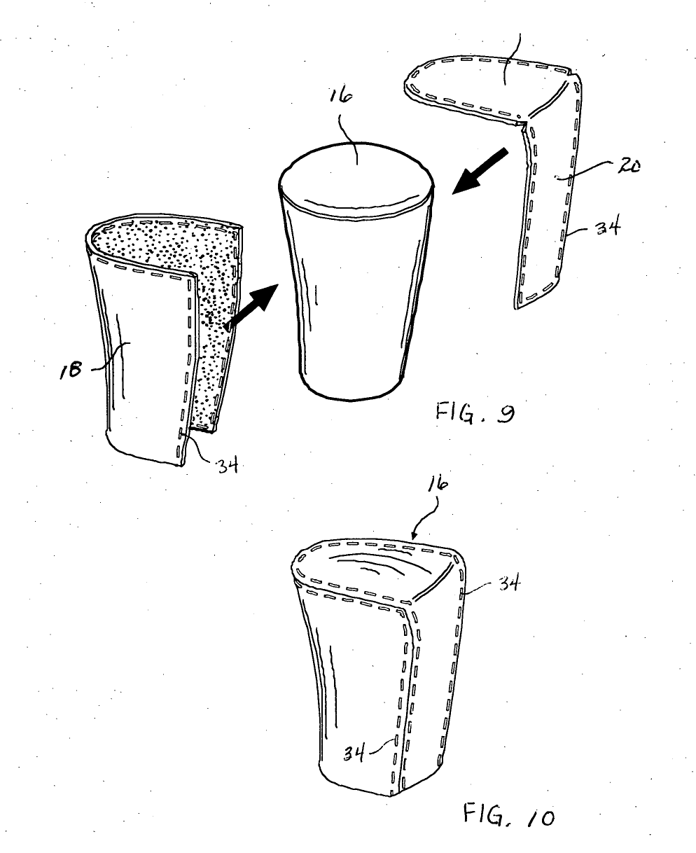

FIG. 9 illustrates the condition of the two pieces 18 and 20 which have been thinned and stitched and coated with adhesive on the rough underside. The pieces are now applied to the surface of the shift knob 16 so that the false-stitched edges are brought into juxtaposition. The step of actually applying the pieces 18 and 20 to the shift knob 16 can be assisted with suitable custom-made jigs which pre-locate the pieces 18 and 20 and cause them to be brought together on the surface of the shift knob 16. Alternatively, these operations can be performed by hand, adhesive being chosen so as to remain unset for several hours so as to allow the pieces 18 and 20 to be manually manipulated until the mating edges of the leather are essentially gapless and all wrinkles have been manually ironed out. The resulting leather-covered shift knob is shown in FIG. 10 having the appearance of sewn or stitched-together pieces of leather which fully cover the exposed surface of the shift knob 16.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is clamed is:

1. A method of producing a leather-covered automotive component comprising the steps of
a. cutting one or more pieces of leather to cover the surface of the component and to define at least two mating edges;
b. hemming the mating edges;
c. thinning the hemmed edges;
d. false stitching the mating edges; and
e. adhesively bonding the leather to the surface of the component with the mating edges in juxtaposition.

2. The method as defined in claim 1 wherein the edges are thinned before the hemming step.

3. (canceled)

4. The method defined in claim 1 wherein the component is a shift knob.

5. The method defined in claim 1 wherein the stitching is French style.
